(19) United States
(12) Patent Application Publication
(10) Pub. No.: US 2009/0002411 A1
(43) Pub. Date: Jan. 1, 2009

(54) METHOD AND APPARATUS TO MAINTAIN IMAGE FORMING APPARATUS

(75) Inventor: Min-su PARK, Seongnam (KR)

Correspondence Address: STANZIONE & KIM, LLP, 919 18TH STREET, N.W., SUITE 440, WASHINGTON, DC, 20006, US

(73) Assignee: Samsung electronics Co., Ltd., Suwon-si (KR)

(21) Appl. No.: 12/137,782

(22) Filed: Jun. 12, 2008

(30) Foreign Application Priority Data
Jun. 27, 2007 (KR) 10-2007-0063811

(51) Int. Cl. B41J 25/308

(52) U.S. Cl. 347/8

(57) ABSTRACT

A method and apparatus to maintain an image forming apparatus. The method includes: detecting an actual separation distance from an initial position of a platen, which moves during maintenance operations, to the maximum separation position of the platen; and compensating distance information to move the platen using the detected actual separation distance and a set separation distance. Therefore, the position on a moving path of the platen, which moves to perform the maintenance operations to maintain a performance of an array inkjet head included in the image forming apparatus, can be compensated, and thus, an optimal maintenance can be performed.

### CROSS-REFERENCE TO RELATED APPLICATIONS

This application claims the benefit of Korean Patent Application No. 10-2007-0063811, filed on Jun. 27, 2007, in the Korean Intellectual Property Office, the disclosure of which is incorporated herein in its entirety by reference.

### BACKGROUND OF THE INVENTION

1. Field of the Invention

The present general inventive concept relates to an image forming apparatus having an array inkjet head, and more particularly, to a method and an apparatus to compensate for a position of a platen according to maintenance operations.

2. Description of the Related Art

In general, an inkjet image forming apparatus forms images by ejecting ink from an inkjet head (shuttle type inkjet head), which reciprocates in a main scanning direction, onto a sheet of paper conveyed in a sub-scanning direction. The inkjet head includes a nozzle portion including a plurality of nozzles through which the ink is injected. Ink droplets that are not injected remain around the nozzle portion. If the nozzle portion is exposed to air when a printing operation is not being performed, the ink droplets around the nozzle portion may harden, and impurities such as fine dust in the air may become attached onto the nozzle portion. The hardened ink or impurities may change an ink injecting direction, thereby degrading the printing quality. In addition, since ink in the nozzles evaporates, the nozzles may become clogged. Therefore, a maintenance process such as a capping operation for separating the nozzle portion from the external air during when the printing operation is not being performed, and a wiping operation for removing impurities from the nozzle portion must be performed.

Recently, a high speed printing operation is performed using an inkjet head (array inkjet head) including a nozzle portion having a length corresponding to the width of the paper, and moving in a main scanning direction. In the inkjet image forming apparatus, such an inkjet head is fixed, and the sheets of paper are conveyed in a sub-scanning direction. Therefore, a driving unit for the inkjet image forming apparatus has a simple structure, and the high speed printing operation can be achieved. In the inkjet image forming apparatus, the length of the nozzle portion corresponding to A4 paper is about 210 mm without considering a printing margin in a width direction of the paper. Since the array inkjet head ejects ink while in a fixed position, unlike the shuttle type inkjet head that reciprocates in the main scanning direction, it is difficult to fix operational problems of the array inkjet head when some of the nozzles are clogged or the ink ejecting direction is changed due to impurities. Therefore, an effective wiping operation must be performed.

Here, a platen is driven to perform maintenance (wiping, spitting, capping, and scraping) and to guide the paper through the conveying path. In particular, a wiper and the platen are engaged with each other through a driving source, and operate along the conveying path formed on a sidewall of the apparatus by speed/position controls of a driving motor. A maintenance operation, that is, wiping, spitting, scraping, or platen opening/closing, is performed according to the position of the platen on the conveying path. However, a stopping position of the platen can vary due to a sample deviation (assembling error, abrasion, load deviation), and thus, the maintenance operation may be improperly performed.

### SUMMARY OF THE INVENTION

The present general inventive concept provides a method and apparatus to maintain an image forming apparatus, by performing an optimal maintenance operation by compensating for a position of a platen, which is involved in the maintenance process to maintain the performance of an array head, on a conveying path in the image forming apparatus including the array head.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept are achieved by providing a method of maintaining an image forming apparatus, the method including: detecting an actual separation distance from an initial position of a platen, which moves during maintenance operations, to the maximum separation position of the platen; and compensating distance information to move the platen using the detected actual separation distance and a set separation distance.

The foregoing and/or other aspects and utilities of the present general inventive concept are achieved by providing an apparatus to maintain an image forming apparatus, the apparatus including: a movement controller to control a movement of a platen, which moves during the maintenance operations, from an initial position of the platen to a maximum separation position of the platen; a distance detector to detect an actual separation distance from the initial position to the maximum separation position; and a distance information compensator to compensate distance information to move the platen using the detected actual separation distance and a set separation distance.

The foregoing and/or other aspects and utilities of the present general inventive concept are achieved by providing a method of calibrating an apparatus to maintain an image forming apparatus, the method including: comparing an actual position of a platen to a corresponding expected position of the platen among a plurality of expected positions available during maintenance of nozzles of a printhead; and compensating distance information to move the platen using the detected actual position and the corresponding expected position.

The compensating distance information can be performed by determining a ratio between the actual position and the corresponding expected position.

The compensating distance information can be performed by determining a ratio between the actual position and the corresponding expected position.

The method may further include performing the calibrating of the apparatus by compensating the set position an amount equal to the set position multiplied by the ratio between the actual position and the corresponding expected position.

The foregoing and/or other aspects and utilities of the present general inventive concept are achieved by providing an apparatus to maintain an image forming apparatus, including: a movement controller to control movement of a platen, which moves during maintenance operations, from an initial position to a maximum movement position of the platen with respect to an inkjet head; a distance detector to detect an actual position of the platen with respect to the initial position; and a distance information compensator to compensate the distance information to move the platen using the detected actual position and a corresponding expected position among a plurality of expected positions provided in a pre-stored table.

The corresponding expected position among the plurality of expected positions can be determined based on a comparison of the plurality of expected positions and the detected actual position.

The apparatus may further include a storage to store the plurality of expected position.

### BRIEF DESCRIPTION OF THE DRAWINGS

The above and other features and advantages of the present general inventive concept will become more apparent by describing in detail exemplary embodiments thereof with reference to the attached drawings in which:

FIG. 1 is a side view of a mechanical structure of an apparatus to maintain an image forming apparatus, wherein the apparatus includes a platen, according to an embodiment of the present general inventive concept;

FIG. 2 is a flowchart illustrating a method of maintaining an image forming apparatus, according to an embodiment of the present general inventive concept;

FIG. 3 is a schematic diagram illustrating the platen of FIG. 1 moving around a nozzle when a maintenance is performed; and

FIG. 4 is a block diagram of an apparatus to maintain an image forming apparatus according to an embodiment of the present general inventive concept.

### DETAILED DESCRIPTION OF THE PREFERRED EMBODIMENTS

A method of maintaining an image forming apparatus according to an embodiment of the present general inventive concept will be described with reference to accompanying drawings. First, however, a mechanical structure of an apparatus to maintain the image forming apparatus will be described as follows. Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

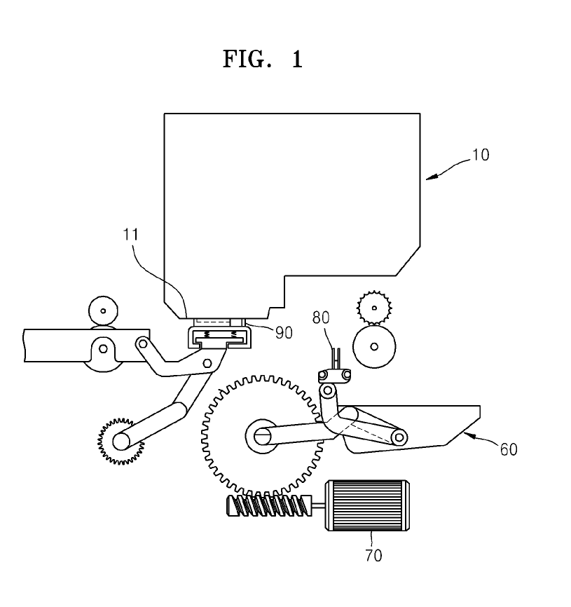

FIG. 1 is a side view illustrating a mechanical structure of an apparatus to maintain an image forming apparatus, according to an embodiment of the present general inventive concept. Referring to FIG. 1, while a platen 60 moves from a right portion to a left portion of an inkjet head 10, a wiper 80 wipes a nozzle portion 11 thereof, and while the platen 60 moves from the left portion to the right portion thereof, the wiper 80 does not contact the nozzle portion 11.

If the nozzle portion 11 is exposed to air when a printing operation is not being performed, any ink droplets remaining around the nozzle portion 11 may harden, and impurities, such as fine dust in the air, may attach onto the nozzle portion 11. The hardened ink or impurities on the nozzle portion 11 may change the ink injecting direction, thereby degrading the printing quality. In addition, since ink in the nozzle portion 11 evaporates, the nozzle portion 11 may become clogged. Since the inkjet head 10 prints an image at a fixed position, a white line is generated on the printed image if some of a plurality of nozzles of the nozzle portion 11 become clogged.

In order to realize high printing quality, the nozzle portion 11 must be maintained at an optimal status to perform a printing operation. Therefore, in order to maintain the nozzle portion 11 at the optimal status, maintenance operations, such as spitting, wiping, scraping, and capping, are performed. The image forming apparatus includes a spittoon (not illustrated) to perform a spitting operation, a wiper 80 to perform a wiping operation, a scraper (not illustrated) to perform a scraping operation, and a capper 90 to perform a capping operation.

When the printing operation is not being performed for a while or when there are nozzles that are not used for a while during the printing operation, the ink in the nozzles and around the nozzles is hardened, causing the viscosity of the ink to increase, and thus, a spitting defect of the nozzles occurs. The spitting operation of the nozzles is to spit the ink a few times during a time period in order to remove the ink from the nozzles. The wiping operation is to remove the hardened ink and impurities around the nozzles by wiping a surface of the nozzle portion 11. The capping operation prevents the nozzles from drying by capping the nozzle portion 11 so as to stop the exposure of the nozzle portion 11 to external air when the printing operation is not being performed for a predetermined period of time.

To perform the maintenance operation, the image forming apparatus includes the capper 90 to cap the nozzle portion 11, and the wiper 80 to wipe the nozzle portion 11, as illustrated in FIG. 1. The platen 60 is located facing the nozzle portion 11, and supports a rear surface of a printing medium, so as to form a portion of a media conveying path. A blade or a roller having a predetermined elasticity can be used as the wiper 80.

A driving source may be used to move the wiper 80 and to move the capper 90. Otherwise, the driving source to move the wiper 80 and the driving source to move the capper 90 may be independently formed with respect to each other. When the length of the nozzle portion 11 in a sub-scanning direction is increased, a moving distance of the platen 60 also increases. In this case, the platen 60 and the wiper 80 can be driven by the same driving source, and the platen 60 and the capper 90 can be driven by the same driving source.

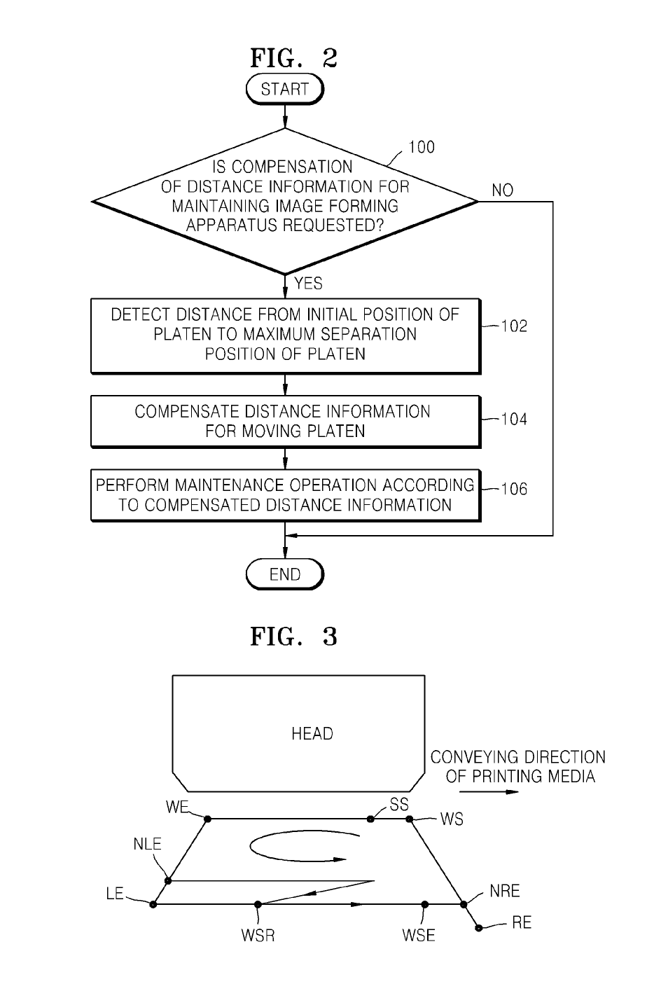

FIG. 2 is a flowchart illustrating a method of maintaining the image forming apparatus according to an embodiment of the present general inventive concept.

At operation 100 it is sensed whether a compensation of the distance information, which represents the moving distance of the platen 60 during the maintenance operation, is required. Here, the distance information is information regarding a relative position of the platen 60 during the maintenance operation as a distance in which the platen 60 moves from the right portion to the left portion of the inkjet head and returns to the original position, as illustrated in FIG. 1. The requirement to compensate the distance information can be determined by sensing a request of a user using an input unit (not illustrated), or sensing a predetermined time period. The request of the user or the occurrence of the predetermined time period is determined as the request to compensate the distance information.

If the distance information is required to be compensated, an actual distance from an initial position of the platen 60 to the maximum separation position of the platen 60 is measured at operation 102.

FIG. 3 schematically illustrates the moving of the platen 60 around the nozzle portion 11 when the maintenance operation is being performed. In FIG. 3, RE, NRE, WS, SS, WE, NLE, LE, WSR, and WSE denote positions of the platen 60. RE represents the rightmost portion of the platen 60, NRE is a position a predetermined distance apart from the initial position of the platen 60, WS denotes a position of starting the wiping operation, SS denotes a position of starting the spitting operation, WE denotes a position of ending the wiping operation, LE denotes the maximum moving distance from the initial position of the platen 60, NLE is a position a predetermined distance apart from the position LE, WSR denotes a return position to perform the scraping operation, and WSE denotes a position of ending the scraping operation. Exemplary information regarding the positions of the platen 60 illustrated in FIG. 3, that is, the distance information, is illustrated in the following Table 1.

TABLE 1

| | | | Compensated |
|---|---|---|---|
| | Reference | Set distance | distance information |
| Position | Symbols | information [mm] | [mm] |
| Right End | RE | 0 | 0 |
| (Platen Open) | | | |
| Near Right End | NRE | 5.00 | 5.00*(α/61.23) |
| Wiping Start | WS | 21.24 | 21.24*(α/61.23) |
| Spit Start | SS | 29.00 | 29.00*(α/61.23) |
| Wiping End | WE | 48.00 | 48.00*(α/61.23) |
| Near Left End | NLE | 56.23 | 56.23*(α/61.23) |
| Left End | LE | 61.23 | α |
| (Platen Close) | | | |
| Wiper Scrapping | WSR | 12.69 | 12.69*(α/61.23) |
| Return | | | |
| Wiper Scrapping | WSE | 32.48 | 32.48*(α/61.23) |
| End | | | |

As illustrated in Table 1, the information regarding the distance from the initial position of the platen 60 to each of the positions of the platen is set in advance. That is, the distance from the initial position RE of the platen 60 to the maximum moving distance LE of the platen 60 is set as 61.23 mm. However, the maximum moving distance LE from the initial position RE of the platen 60 can be different depending on the image forming apparatuses due to an assembling error of the apparatus, an abrasion of the apparatus, or a load deviation. The purpose of operation 102 is to detect the actual separation distance from the initial position of the platen 60 to the maximum moving position LE of the platen 60. Here, the maximum moving position LE of the platen 60 from the initial position RE is the position at which the platen 60 cannot further move to the left. The actual distance from the initial position RE to the maximum moving position LE can be measured by using an encoder or a distance-measuring sensor. The actual separation distance from the initial position to the maximum moving position is a of Table 1.

After performing the operation 102, the distance information to move the platen is compensated using the detected actual separation distance and the set separation distance (operation 104). For example, the distance from the initial position of the platen to the maximum separation position of the platen 60 is set as 61.23 mm in advance. However, the actual distance from the initial position of the platen to the maximum separation position of the platen 60 is α. Therefore, when a ratio between the actual separation distance and the set separation distance is calculated, other distance information set in advance can be compensated. For example, in Table 1, the compensated distance information is the information obtained by compensating the set distance information by multiplying the set distance information by the ratio between the actual separation distance α and the set separation distance 61.23 mm.

After performing operation 104, the maintenance operation is performed involving the platen 60 according to the compensated distance information (operation 106). As illustrated in Table 1, the platen 60 is moved based on the compensated distance information, and the maintenance operation, that is, the wiping operation or the spitting operation, is performed involving the platen 60. Therefore, the position of the platen 60, to perform the maintenance operation, can be exact in any image forming apparatus, and thus, an optimal maintenance operation can be performed. The maintenance operation can be performed when the image forming apparatus is not performing the printing operation, or when the printing operation is performed.

The maintenance operation is performed in the image forming apparatus having the array inkjet head that includes a plurality of unit heads, each of which has a width that is wider than that of a printing medium.

The present general inventive concept can also be embodied as computer readable codes/instructions/programs on a computer readable recording medium. That is, a computer readable recording medium that stores a program to perform a process of detecting the actual separation distance from the initial position of the platen to the maximum separation position of the platen, which moves in communication with the maintenance operation, and a process of compensating the distance information to move the platen based on the actual separation distance and the set separation distance is another technical feature of the present general inventive concept.

For example, the embodiments of the present general inventive concept can be written as computer programs and can be implemented in general-use digital computers that execute the codes/instructions/programs using a computer readable recording medium. Examples of the computer readable recording medium include magnetic storage media (e.g., ROM, floppy disks, hard disks, etc.), optical recording media (e.g., CD-ROMs, or DVDs), and storage media such as carrier waves (e.g., transmission through the Internet). The computer readable recording medium can also be distributed over network coupled computer systems so that the computer readable code is stored and executed in a distributed fashion. Also, functional programs, codes, and code segments to accomplish the present general inventive concept can be easily construed by programmers skilled in the art to which the general inventive concept pertains.

Hereinafter, an apparatus to maintain the image forming apparatus according to an embodiment of the present general inventive concept will be described with reference to accompanying drawings.

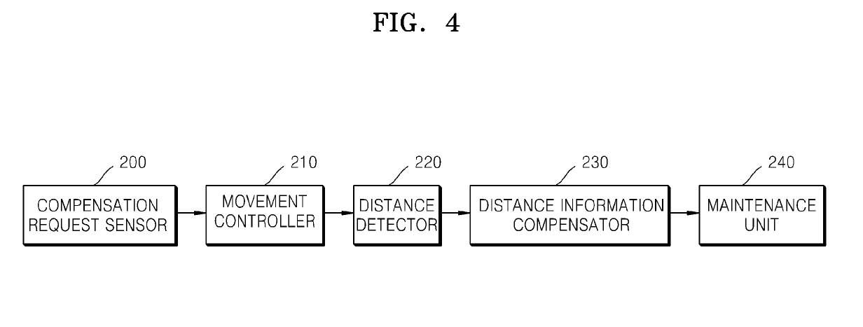

FIG. 4 is a block diagram of an apparatus to maintain the image forming apparatus of the current embodiment, according to an embodiment of the present general inventive concept. The apparatus to maintain the image forming apparatus includes a compensation request sensor 200, a movement controller 210, a distance detector 220, a distance information compensator 230, and a maintenance unit 240.

The compensation request sensor 200 senses whether the compensation of the distance information is requested, and outputs the sensing result to the movement controller 210. The distance information is the information representing the relative position of the platen 60 in the maintenance operation as a distance that the platen 60 moves from the right portion to the left portion and returns to the right portion. The compensation request sensor 200 senses the request of the user to compensate for the distance information using an input unit, or senses the occurrence of a predetermined time period as the request for the compensation of the distance information.

The movement controller 210 controls the movement of the platen 60 from the initial position of the platen 60 to the maximum separation position of the platen 60 that moves during the maintenance operation, and outputs a control signal to the distance detector 220. The maximum separation position of the platen 60 is the position at which the platen 60 cannot move further to the left portion of the inkjet head. The movement controller 210 controls the movement of the platen 60 so that the platen 60 can move to the left as much as possible. The movement controller 210 drives a motor 70 that drives the platen 60 to move the platen 60 to the left portion of the inkjet head 10, as illustrated in FIG. 1.

When the distance detector 220 receives the control signal from the movement controller 210, the distance detector 220 detects the actual separation distance from the initial position of the platen 60 to the maximum separation position, and outputs the detected result to the distance information compensator 230. The distance detector 220 counts the moving distance of the platen 60 from the initial position to the maximum separation position using an encoder or a distance-measuring sensor, and thus, detects the actual separation distance.

The distance information compensator 230 compensates for the distance information to move the platen 60 using the actual separation distance detected by the distance detector 220 and the set separation distance, and outputs the compensated result to the maintenance unit 240. To do this, the distance information compensator 230 stores table values of the set distance information as shown in Table 1 in advance. For example, the maximum separation distance that is set in advance is 61.23 mm in Table 1, and the actual separation distance is α, and thus, the distance information compensator 230 multiplies the set distance information by the ratio between the actual separation distance α and the set separation distance 61.23 mm to obtain the compensated distance information.

The maintenance unit 240 performs the maintenance operation involving the platen 60 according to the distance information compensated by the distance information compensator 230. The maintenance unit 240 includes a unit to drive the elements illustrated in FIG. 1, and performs the wiping operation and the spitting operation. The maintenance unit 240 can perform the maintenance operation when the image forming apparatus is not forming the images, or can perform the maintenance when the image forming operation is performed.

The apparatus is used to maintain an image forming apparatus having an array inkjet head.

According to the method and apparatus to maintain the image forming apparatus, according to embodiments of the present general inventive concept, the position of the platen on the moving path of the platen is compensated, and the platen moves during the maintenance operations (wiping, spitting, capping, and scraping) in the image forming apparatus having the array inkjet head that includes a plurality of printheads, and thus, the optimal maintenance operation can be performed.

While the present general inventive concept has been particularly illustrated and described with reference to exemplary embodiments thereof, it will be understood by one of ordinary skill in the art that various changes in form and details may be made therein without departing from the spirit and scope of the present general inventive concept as defined by the following claims.

What is claimed is:

1. A method of maintaining an image forming apparatus, the method comprising:
detecting an actual separation distance from an initial position of a platen, which moves during maintenance operations, to the maximum separation position of the platen; and
compensating distance information to move the platen using the detected actual separation distance and a set separation distance.

2. The method of claim 1, wherein the detecting of the actual separation distance is performed using one of an encoder and a distance-measuring sensor.

3. The method of claim 1, further comprising:
sensing whether the compensation of the distance information is requested.

4. The method of claim 3, wherein the sensing of the compensation request is by sensing a request of a user or an occurrence of a predetermined time period.

5. The method of claim 1, further comprising:
performing the maintenance operations involving the platen according to the compensated distance information.

6. The method of claim 5, wherein the maintenance operations are performed when the image forming apparatus does not perform an operation for forming images.

7. The method of claim 5, wherein the maintenance operations are performed while the image forming apparatus performs the image forming operation.

8. The method of claim 1, wherein the method is performed in the image forming apparatus having an array head.

9. A computer readable recording medium having embodied thereon a computer program to execute the following operations:
detecting an actual separation distance from an initial position of a platen, which moves during maintenance operations, to the maximum separation position of the platen; and
compensating distance information to move the platen using the detected actual separation distance and a set separation distance.

10. An apparatus to maintain an image forming apparatus, the apparatus comprising:
a movement controller to control a movement of a platen, which moves during the maintenance operations, from an initial position of the platen to a maximum separation position of the platen;
a distance detector to detect an actual separation distance from the initial position to the maximum separation position; and
a distance information compensator to compensate distance information to move the platen using the detected actual separation distance and a set separation distance.

11. The apparatus of claim 10, wherein the distance detector detects the actual separation distance using one of an encoder and a distance-measuring sensor.

12. The apparatus of claim 10, further comprising:
a compensation request sensor to sense whether the compensation of the distance information is requested.

13. The apparatus of claim 12, wherein the compensation request sensor senses a request of a user or an occurrence of a predetermined time period.

14. The apparatus of claim 10, further comprising:
a maintenance unit to perform the maintenance operations involving the platen according to the compensated distance information.

15. The apparatus of claim 14, wherein the maintenance unit performs the maintenance operations when the image forming apparatus does not perform the operations to form images.

16. The apparatus of claim 14, wherein the maintenance unit performs the maintenance operations while the image forming apparatus performs the image forming operation.

17. The apparatus of claim 10, wherein the apparatus performs the maintenance operations in the image forming apparatus having an array head.

18. A method of calibrating an apparatus to maintain an image forming apparatus, the method comprising:
comparing an actual position of a platen to a corresponding expected position of the platen among a plurality of expected positions available during maintenance of nozzles of a printhead; and
compensating distance information to move the platen using the detected actual position and the corresponding expected position.

19. The method of claim 18, wherein the plurality of expected positions are pre-calculated positions stored in a memory.

20. The method of claim 19, wherein the compensating distance information is performed by determining a ratio between the actual position and the corresponding expected position.

21. The method of claim 20, further comprising:
performing the calibrating of the apparatus by compensating the set position an amount equal to the set position multiplied by the ratio between the actual position and the corresponding expected position.

22. An apparatus to maintain an image forming apparatus, comprising:
a movement controller to control movement of a platen, which moves during maintenance operations, from an initial position to a maximum movement position of the platen with respect to an inkjet head;
a distance detector to detect an actual position of the platen with respect to the initial position; and
a distance information compensator to compensate the distance information to move the platen using the detected actual position and a corresponding expected position among a plurality of expected positions provided in a pre-stored table.

23. The apparatus of claim 22, wherein the corresponding expected position among the plurality of expected positions is determined based on a comparison of the plurality of expected positions and the detected actual position.

24. The apparatus of claim 23, further comprising:
a storage to store the plurality of expected positions.
